(19) United States
(12) Patent Application Publication
(10) Pub. No.: US 2026/0120304 A1
(43) Pub. Date: Apr. 30, 2026

(54) DEVICE AND SPATIAL RECONSTRUCTION METHOD THEREOF

(71) Applicant: LG ELECTRONICS INC., Seoul (KR)

(72) Inventors: Wooseong CHUNG, San Jose, CA (US); Hyunchul LEE, Mountain View, CA (US); Jacob SONG, Cupertino, CA (US); Sanghyun BYUN, San Jose, CA (US)

(73) Assignee: LG ELECTRONICS INC., Seoul (KR)

(21) Appl. No.: 19/368,967

(22) Filed: Oct. 24, 2025

Related U.S. Application Data
(60) Provisional application No. 63/711,663, filed on Oct. 24, 2024.
(60) Provisional application No. 63/711,671, filed on Oct. 24, 2024.

(30) Foreign Application Priority Data
Oct. 15, 2025 (WO) PCT/KR2025/016249

(51) Int. Cl. G06T 7/50; G06T 7/10; G06T 17/20

(52) U.S. Cl. CPC G06T 7/50; G06T 7/10; G06T 17/20; G06T 2207/20081; G06T 2207/20084

(57) ABSTRACT

A device generating a reconstructed 3D mesh from a single image is provided. According to one embodiment of the present disclosure, a device may comprise a memory configured to store a depth refinement model; and a processor configured to: acquire a single image representing an indoor space, generate an initial depth map from the single image, generate a plurality of sampling data from the single image, generate a plurality of depth maps from the initial depth map and the plurality of sampling data through the depth refinement model, calculate a plurality of losses representing differences between each of the plurality of depth maps and a correct depth map, and train the depth refinement model such that a sum of the calculated plurality of losses is minimized.

### CROSS-REFERENCE TO RELATED APPLICATIONS

Pursuant to 35 U.S.C. § 119, this application claims the benefit of an earlier filing date and right of priority to International Application No. PCT/KR2025/016249, filed on Oct. 15, 2025, and also claims the benefit of U.S. Provisional Patent Application Nos. 63/711,663, filed on Oct. 24, 2024, and 63/711,671, filed on Oct. 24, 2024, the contents of which are all incorporated by reference herein in their entirety.

### BACKGROUND OF THE INVENTION

### 1. Field of the Invention

The present invention relates to an artificial intelligence device, and more particularly, to an artificial intelligence device capable of reconstructing an indoor space through a single image using artificial intelligence.

### 2. Discussion of the Related Art

Traditionally, applications such as spatial measurement and design simulation have used LiDAR (Light Detection and Ranging) technology. LiDAR uses a laser to measure precise distance and depth information, achieving high precision.

However, when performing spatial simulation using conventional LiDAR technology, there are the following problems.
1. High hardware dependency: A LiDAR sensor is currently only available in some high-end smartphones, and only about 10% of smartphone users own devices with LiDAR capabilities, making it difficult for this technology to become widespread or widely used.
2. Need for lightweight model: To operate in real time on device such as smartphone, the model used must be lightweight and efficient. However, models that process LiDAR data are complex and computationally intensive, putting a heavy burden on the device.
3. Lack of consistency between sampling methods: Existing monocular metric depth estimation models have a problem in that they fail to properly check consistency between different sampling methods. This reduces the accuracy of depth estimation across the entire image, posing a critical weakness, especially in applications requiring precise measurements, such as appliance placement.

### SUMMARY OF THE INVENTION

The purpose of the present disclosure may be to provide a method for reconstructing a three-dimensional indoor space through a single image even on a low-spec edge device.

The purpose of the present disclosure may be to implement a model small enough to be executed on an edge device through a novel methodology that iteratively improves depth estimation using multiple sampled data.

The purpose of the present disclosure may be to improve the accuracy of depth estimation for an image by checking the consistency of different sampling methods.

According to one embodiment of the present disclosure, a device may comprise a memory configured to store a depth refinement model; and a processor configured to: acquire a single image representing an indoor space, generate an initial depth map from the single image, generate a plurality of sampling data from the single image, generate a plurality of depth maps from the initial depth map and the plurality of sampling data through the depth refinement model, calculate a plurality of losses representing differences between each of the plurality of depth maps and a correct depth map, and train the depth refinement model such that a sum of the calculated plurality of losses is minimized.

A method for reconstructing a space of a device according to an embodiment of the present disclosure may comprise: acquiring a single image representing an indoor space; generating an initial depth map from the single image; generating a plurality of sampling data from the single image; generating a plurality of depth maps from the initial depth map and the plurality of sampling data through a depth refinement model; calculating a plurality of losses representing differences between each of the plurality of depth maps and a correct depth map; and training the depth refinement model such that a sum of the calculated plurality of losses is minimized.

A non-transitory recording medium storing computer-readable instructions that, when executed by a device according to one embodiment of the present disclosure, cause the device to perform operations, the operations may comprises: acquiring a single image representing an indoor space; generating an initial depth map from the single image; generating a plurality of sampling data from the single image; generating a plurality of depth maps from the initial depth map and the plurality of sampling data through a depth refinement model; calculating a plurality of losses representing differences between each of the plurality of depth maps and a correct depth map; and training the depth refinement model such that a sum of the calculated plurality of losses is minimized.

According to an embodiment of the present disclosure, a three-dimensional indoor space may be reconstructed through a single image even on the low-spec edge device, thereby eliminating device specification limitations.

According to embodiments of the present disclosure, the accuracy of metric estimation of a model may be improved by comparing depth maps at multiple viewpoints.

According to embodiments of the present disclosure, initial mesh rendering may be performed using an off-the-shelf depth estimation network, resulting in faster (lower resource requirement) display of results on a low-power device (e.g., CPU-only).

### BRIEF DESCRIPTION OF THE DRAWINGS

FIG. 1 is a block diagram for illustrating elements of an artificial intelligence device according to an embodiment of the present disclosure.

FIG. 2 is a diagram for illustrating the configuration of an artificial intelligence server according to an embodiment of the present disclosure.

FIGS. 3 and 4 are drawings for explaining an artificial intelligence-based spatial reconstruction method of an artificial intelligence device according to one embodiment of the present disclosure.

FIG. 5 is a drawing for explaining the configuration of an artificial intelligence device according to another embodiment of the present disclosure.

FIG. 6 is a flowchart illustrating a method for generating a reconstructed image from a captured image according to one embodiment of the present disclosure.

FIG. 7 is a sequence diagram illustrating an artificial intelligence-based spatial reconstruction method of a system according to one embodiment of the present disclosure.

FIG. 8 is a sequence diagram of a system for explaining a method for providing a customized retail experience service according to one embodiment of the present disclosure.

FIG. 9 is a drawing illustrating the configuration of a system according to another embodiment of the present disclosure.

FIG. 10 is a diagram illustrating a scenario for providing a customized retail experience service according to one embodiment of the present disclosure.

FIG. 11 is a drawing for explaining the configuration of a digital human module according to one embodiment of the present disclosure.

### DETAILED DESCRIPTION OF THE PREFERRED EMBODIMENTS

Artificial intelligence refers to the field of researching artificial intelligence or methodology to create it, and machine learning refers to the field of defining various problems dealt with in the field of artificial intelligence and researching methodology to solve them.

Machine learning is also defined as an algorithm that improves the performance of a task through consistent experience.

Artificial Neural Network (ANN) is a model used in machine learning, it may refer to an overall model with problem-solving capability that is composed of artificial neurons (nodes) that form a network through the combination of synapses.

Artificial neural network may be defined by connection pattern between neurons in different layers, a learning process that updates model parameter, and an activation function that generates output value.

An artificial neural network may include an input layer, an output layer, and optionally one or more hidden layers. Each layer may include one or more neurons, and the artificial neural network may include synapse connecting neurons. In an artificial neural network, each neuron may output the input signals input through the synapse, weight, and value of activation function for bias.

Model parameter refer to a parameter determined through learning and includes the weight of synapse connection and the bias of neurons. Hyperparameter refer to a parameter that must be set before learning in a machine learning algorithm and includes learning rate, number of repetition, mini-batch size, initialization function, etc.

The purpose of learning an artificial neural network may be seen as determining model parameter that minimize the loss function. The loss function may be used as an indicator to determine optimal model parameter during the learning process of an artificial neural network.

Machine learning may be classified into supervised learning, unsupervised learning, and reinforcement learning depending on the learning method.

Supervised learning refers to a method of training an artificial neural network with a label for the learning data given, a label may mean the correct answer (or result value) that the artificial neural network must infer when learning data is input to the artificial neural network.

Unsupervised learning may refer to a method of training an artificial neural network in a state where no label for training data is given.

Reinforcement learning may refer to a learning method in which an agent defined within an environment learns to select an action or action sequence that maximizes the cumulative reward in each state.

Among artificial neural networks, machine learning implemented with a deep neural network (DNN) that includes multiple hidden layers is also called deep learning, and deep learning is a part of machine learning.

Hereinafter, machine learning is used to include deep learning.

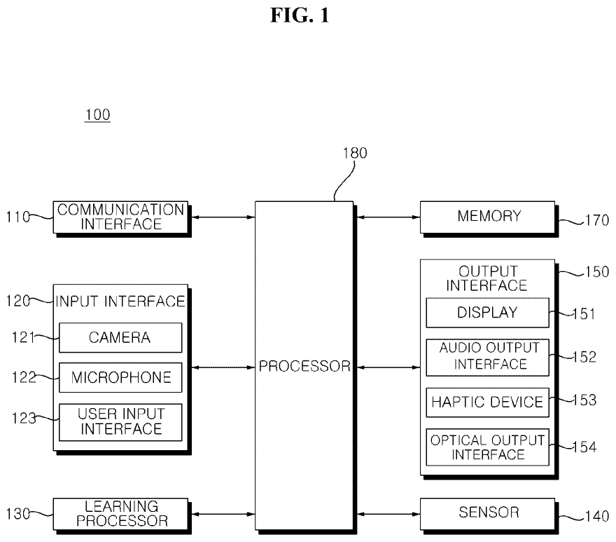

FIG. 1 is a block diagram for illustrating elements of an artificial intelligence device according to an embodiment of the present disclosure.

The artificial intelligence device 100 may be implemented as a fixed or movable device such as a TV, a projector, a mobile phone, a smartphone, a desktop computer, a laptop, a digital broadcasting terminal, a PDA (personal digital assistant), a PMP (portable multimedia player), a navigation, a tablet PC, a wearable device, and a set-top boxe (STB), a DMB receiver, a radio, a washing machine, a refrigerator, a desktop computer, a digital signage, a robot, a vehicle, etc.

Referring to FIG. 1, the artificial intelligence device 100 may include a communication interface 110, an input interface 120, a learning processor 130, a sensor 140, an output interface 150, a memory 170, and a processor 180.

The communication interface 110 may transmit and receive data with external device such as other artificial intelligence device or the AI server 200 using wired or wireless communication technology. For example, the communication interface 110 may transmit and receive sensor information, user input, learning model, and control signal with external device.

Communication technologies used by the communication interface 110 include Global System for Mobile communication (GSM), Code Division Multi Access (CDMA), Long Term Evolution (LTE), 5G, Wireless LAN (WLAN), and Wireless-Fidelity (Wi-Fi)., Bluetooth (Bluetooth), RFID (Radio Frequency Identification), Infrared Data Association (IrDA), ZigBee, NFC (Near Field Communication), etc.

The input interface 120 may acquire various types of data.

The input interface 120 may include a camera 121 for capturing image, a microphone 122 for receiving audio signals, and a user input interface 123 for receiving information from a user.

The camera 121 or the microphone 122 is treated as a sensor, and the signal obtained from the camera 121 or the microphone 122 may be called sensing data or sensor information.

The input interface 120 may obtain training data for model learning and input data to be used when obtaining an output using the learning model. The input interface 120 may acquire unprocessed input data, and in this case, the processor 180 or the learning processor 130 may extract input feature by preprocessing the input data.

The camera 121 processes image frame such as still image or moving image obtained by an image sensor in video call mode or photographing mode. Processed image frame may be displayed on display 151 or stored in memory 170.

The microphone 122 processes external acoustic signal into electrical voice data. The processed voice data may be utilized in various ways depending on the function (or application being executed) being performed by the artificial intelligence device 100. Meanwhile, various noise removal algorithms may be applied to the microphone 122 to remove noise generated in the process of receiving an external acoustic signal.

The user input interface 123 is for receiving information from the user, when information is input through the user input interface 123, the processor 180 may control the operation of the artificial intelligence device 100 to correspond to the input information.

The user input interface 123 is a mechanical input means (or mechanical key, for example, a button, dome switch, jog wheel, or jog switch located on the front/rear or side of the artificial intelligence device 100). etc.) and a touch input means.

As an example, the touch input may consist of a virtual key, soft key, or visual key displayed on the touch screen through software processing, or a touch key placed in a part other than the touch screen.

The learning processor 130 may train a model composed of an artificial neural network using training data. The learned artificial neural network may be referred to as a learning model. A learning model may be used to infer a result value for new input data other than learning data, and the inferred value may be used as the basis for a decision to perform an operation.

The learning processor 130 may perform AI processing together with the learning processor 240 of the AI server 200.

The learning processor 130 may include memory integrated or implemented in artificial intelligence device 100. The learning processor 130 may be implemented using the memory 170, an external memory directly coupled to the artificial intelligence device 100, or a memory maintained in an external device.

The sensor 140 may obtain at least one of internal information of the artificial intelligence device 100, information on the surrounding environment of the artificial intelligence device 100, or user information using various sensors.

The sensor 140 may include at least one of a proximity sensor, an illumination sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar sensor, or a radar sensor.

The output interface 150 may generate output related to vision, hearing, or tactile sensation.

The output interface 150 may include a display 151 that outputs an image, an audio output interface 152 that outputs audio, a haptic device 153 that outputs tactile information, and an optical output interface 154 that outputs light.

The display 151 displays (outputs) information processed by the artificial intelligence device 100. For example, the display 151 may display execution screen information of an application running on the artificial intelligence device 100, or user interface (UI) and graphic user interface (GUI) information according to the execution screen information.

The display 151 may be implemented as a touch screen by forming a mutual layer structure or being integrated with the touch sensor. The touch screen functions as a user input interface 123 that provides an input interface between the artificial intelligence device 100 and the user, and may simultaneously provide an output interface between the artificial intelligence device 100 and the user.

The audio output interface 152 may output audio data received from the communication interface 110 or stored in the memory 170 in call signal reception, call mode or recording mode, voice recognition mode, broadcast reception mode, etc.

The audio output interface 152 may include at least one of a receiver, a speaker, or a buzzer.

The haptic device 153 generates various tactile effects that the user may feel. A representative example of a tactile effect generated by the haptic device 153 may be vibration.

The light output interface 154 uses light from the light source of the artificial intelligence device 100 to output a signal to notify that an event has occurred. Examples of events that occur in the artificial intelligence device 100 may include receiving a message, receiving a call signal, a missed call, an alarm, a schedule notification, receiving an email, receiving information through an application, etc.

The memory 170 may store data supporting various functions of the artificial intelligence device 100. For example, the memory 170 may store input data obtained from the input interface 120, learning data, learning model, learning history, etc.

The processor 180 may determine at least one executable operation of the artificial intelligence device 100 based on information determined or generated using a data analysis algorithm or a machine learning algorithm.

The processor 180 may control the elements of the artificial intelligence device 100 to perform the determined operation.

To this end, the processor 180 may request, search, receive, or utilize data from the learning processor 130 or the memory 170, and may control elements of the artificial intelligence device 100 to be performed an operation that is predicted or an operation that is determined to be desirable among the at least one executable operation.

If linkage with an external device is necessary to perform a determined operation, the processor 180 may generate a control signal to control the external device and transmit the generated control signal to the external device.

The processor 180 may obtain intent information for user input and determine the user's request based on the obtained intent information.

The processor 180 may obtain intent information corresponding to the user input using at least one of a STT (Speech To Text) engine for converting voice input into a character string or a Natural Language Processing (NLP) engine for acquiring intent information of natural language.

At least one of the STT engine and the NLP engine may be composed of at least a portion of an artificial neural network learned according to a machine learning algorithm. And, at least one of the STT engine or the NLP engine may be learned by the learning processor 130, learned by the learning processor 240 of the AI server 200, or learned by distributed processing thereof.

The processor 180 may collect history information including the user's feedback on the operation of the artificial intelligence device 100, to store it in the memory 170 or the learning processor 130 or the AI server 200, etc. and transmit it to external device. The collected historical information may be used to update the learning model.

The processor 180 may control at least some of the elements of the artificial intelligence device 100 to run an application program stored in the memory 170.

The processor 180 may operate two or more of the elements included in the artificial intelligence device 100 in combination with each other in order to run the application program.

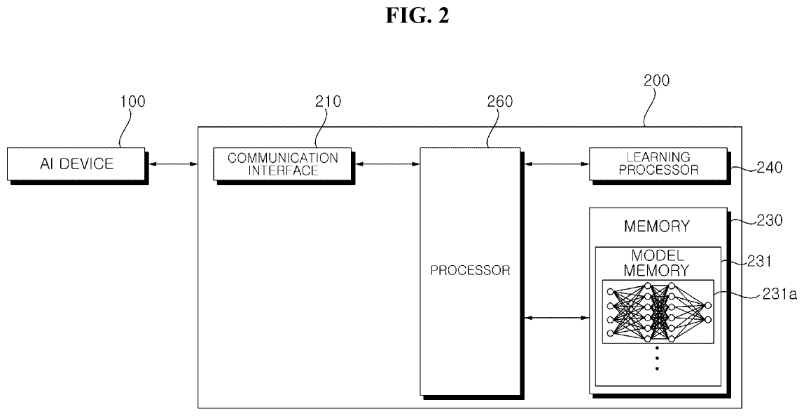

FIG. 2 is a diagram for illustrating the configuration of an artificial intelligence server according to an embodiment of the present disclosure.

Referring to FIG. 2, the AI server 200 may refer to a device that trains an artificial neural network using a machine learning algorithm or uses a learned artificial neural network.

The AI server 200 may be composed of a plurality of servers to perform distributed processing, and may be defined as a 5G network. The AI server 200 may be included as a part of the artificial intelligence device 100 and may perform at least part of the AI processing.

The AI server 200 may include a communication interface 210, a memory 230, a learning processor 240, and a processor 260.

The communication interface 210 may transmit and receive data with an external device such as the artificial intelligence device 100.

The memory 230 may include a model memory 231. The model memory 231 may store a model (or artificial neural network, 231a) that is being trained or has been learned through the learning processor 240.

The learning processor 240 may train the artificial neural network 231a using training data. The learning model may be used while mounted on the AI server 200 of the artificial neural network, or may be mounted and used on an external device such as the artificial intelligence device 100.

The learning model may be implemented in hardware, software, or a combination of hardware and software. When part or all of the learning model is implemented as software, one or more instructions constituting the learning model may be stored in the memory 230.

The processor 260 may infer a result value for new input data using a learning model and generate a response or control command based on the inferred result value.

A LLM is an artificial intelligence language model pre-trained on large-scale text data and it understands the meaning and context of natural language and may perform various language generation and processing tasks. The LLM may output natural language-based response from an input prompt.

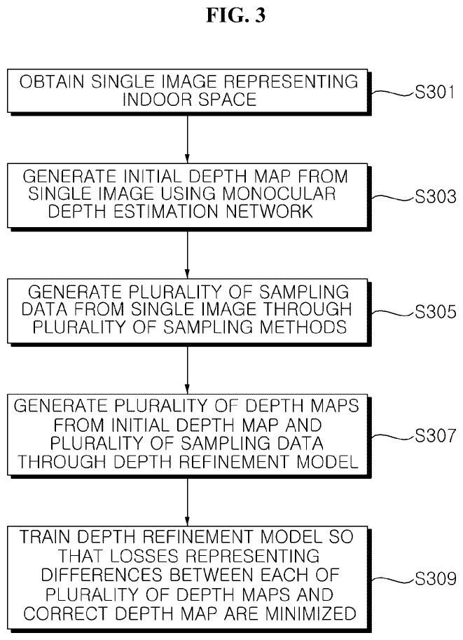

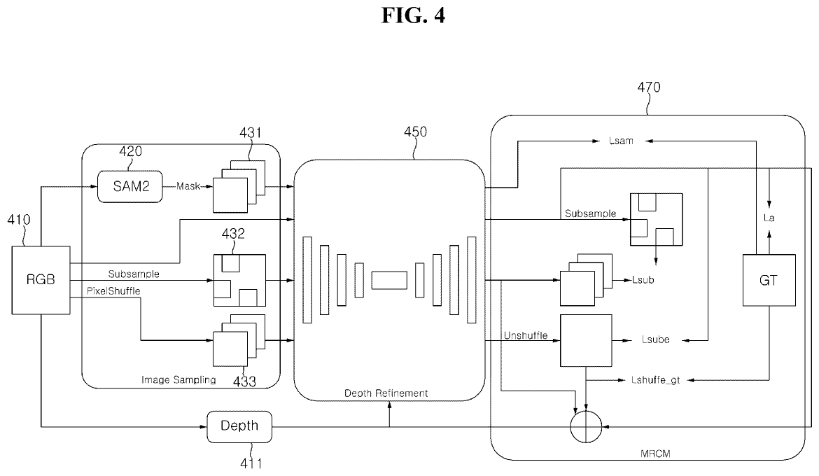

FIGS. 3 and 4 are drawings for explaining an artificial intelligence-based spatial reconstruction method of an artificial intelligence device according to one embodiment of the present disclosure.

In particular, FIGS. 3 and 4 are drawings explaining the learning process of a depth refinement model that reconstructs an indoor space (or indoor scene) from a single image based on AI.

Referring to FIG. 3, the processor 180 of the artificial intelligence device 100 may obtain a single image 410 representing an indoor space S301.

The single image 410 may be an RGB image capturing an indoor space.

The processor 180 may generate an initial depth map 411 from the single image 410 using a monocular depth estimation network S303.

The monocular depth estimation network may be an off-the-shelf monocular depth estimation model. The monocular depth estimation network may be an artificial neural network-based model trained to estimate a depth of each of a plurality of pixels constituting the single image from the single image.

The processor 180 may estimate the depth of each of the plurality of pixels from the single image 410 with unknown camera parameters through the monocular depth estimation network stored in the memory 170, and generate an initial depth map 411 based on an estimation result. The depth map may be a two-dimensional image in which distance information from a camera viewpoint to each pixel in the image is encoded as a pixel brightness.

The initial depth map 411 may be not perfect and may contain a lot of noise, so a more accurate and cleaner depth map may be generated through a depth refinement model 450 described later.

The processor 180 may generate a plurality of sampling data from the single image 410 through a plurality of sampling methods S305.

Step S305 may be performed before step S303, or may be performed simultaneously.

Each of the plurality of sampling methods may be a method of extracting sampling data 431, 432, 433 from the single image 410 in RGB format.

The plurality of sampling methods may include a SAM 2 (Segment Anything Model 2, 420)-based segmentation mask method, a random image segment sub-sampling method, and a pixel shuffling method.

The SAM 2-based segmentation mask method may be a method for automatically generating a segmentation mask for each of a plurality of objects within an image. The segmentation mask may be image-type information indicating a shape and a position of each object. The segmentation mask may be a type of sampling data. SAM 2 420 may generate a plurality of segmentation masks from the single image 410. Each segmentation mask 431 may provide information about a boundary of an object within the image. The segmentation masks 431 may be referred to as a first sampling data 431.

The random image segment subsampling method may be a method of dividing an image into a plurality of image segments of a small size and randomly selecting some of the divided plurality of image segments. The randomly selected image segments may be a type of sampling data. The image segment 432 may provide information about local feature within the image (or information about the location of an object). The image segment 432 may be referred to as a second sampling data 432.

The pixel shuffling method may be a method of generating pixel shuffling data 433 by converting a resolution and channel information of an image. Instead of lowering a spatial resolution of the image, the pixel shuffling method may be a method of generating pixel shuffling data 433 by moving information equivalent to the lowered resolution to the channel axis. The pixel shuffling data 433 may provide a spatial clue. The pixel shuffling data 433 may be referred to as a third sampling data 433.

The processor 180 may generate a plurality of depth maps from the initial depth map 411 and sampling data 431, 432, 433 through the depth refinement model 450 S307.

The depth refinement model 450 may be a model that generates multiple refined depth maps based on the single image 410, the initial depth map 411 with added noise, and sampled data 431, 432, 433 using a lightweight U-Net-based diffusion layer. The depth refinement model 450 may be referred to as a depth refinement diffusion layer U-Net.

The depth refinement model 450 may be a U-Net-based model having a U-shaped structure in which the encoder and decoder are symmetrically connected with a skip connection.

Light noise may be added to the initial depth map 411. This is a variation of a data augmentation technique, intended to force refinement of the initial depth map 411 with added noise. Accordingly, the depth refinement model 450 may be trained to be less sensitive to a noise, more robust, and capable of reconstructing details.

The depth refinement model 450 may include an encoder and decoder based on a residual network-like block (ResNet-like Block). A ResNet-like Block is a block that borrows a core structure of a ResNet (Residual Network, residual network), and is characterized by adding a path that skips information and directly transmits it, rather than simply stacking layers.

The encoder may compress (or downsample) the initial depth map 411 with added noise and the sampling data 431, 432, 433 to output encoded data (feature map or feature vector). The encoded data may be a compressed feature map of the initial depth map 411 with added noise and the sampling data 431, 432, 433. The feature map may include high-level semantic features. The encoded data may include a plurality of feature maps. Each feature map may be a compressed map of the initial depth map 411 with added noise and each sampling data.

A feature map may be hierarchically compressed by passing them through blocks contained in the encoder. The encoder may extract and compress meaningful features by considering not only depth information but also information about a boundary of the object, a positional feature of the object, and a spatial cue of the object.

The decoder may restore the feature map output from the encoder into a high-resolution, refined depth map.

The encoder and decoder may be connected via a skip connection. The skip connection may be a method in which feature maps extracted from each of the encoder's multiple layers are directly passed to a corresponding decoder layer. The skip connection may preserve low-level details and spatial location information that may otherwise be lost during the encoder's compression process. The encoder layer and the skip-connected decoder layer may be based on the same sampled data.

The decoder may generate a refined depth map using the boundary of the object obtained through the first sampling data 431, the location of the object obtained through the second sampling data 432, and the spatial clue obtained through the third sampling data 433.

In this way, the depth refinement model 450 may output a plurality of depth maps using the initial depth map 411 and various sampled data 431, 432, 433. The plurality of depth maps may be referred to as the plurality of refined depth maps.

The processor 180 may train the depth refinement model 450 so that losses representing differences between each of the plurality of depth maps and a correct depth map are minimized S309.

The processor 180 may train the depth refinement model 450 through a multi-resolution consistency module MRCM, 470. The MRCM 470 may be included in either the processor 180 or the learning processor 130, or may be provided separately.

MRCM 470 may compare each of the plurality of depth maps with the correct depth map (Ground Truth, GT) and calculate and sum a plurality of losses.

Referring to FIG. 4, a first loss Lsam may represent the difference between a first depth map generated based on the first sampling data 431 and the correct depth map.

A second loss Lsub may represent the difference between a second depth map generated based on the second sampling data 432 and the correct depth map.

A third loss Lshuffle_gt may represent the difference between a third depth map generated based on the third sampling data 433 and the correct depth map.

A fourth loss Lsube may represent the difference between the compressed feature map based on the third sampling data 433 and the correct depth map.

The loss adder 471 included in the MRCM 470 may add the first loss Lsam, the second loss Lsub, the third loss Lshuffle_gt, and the fourth loss Lsube. The result of adding the losses may be used to update the weights of the depth refinement model 450 through a backpropagation.

The processor 180 may update the weights of the depth refinement model 450 by adding the first to fourth losses so that the added result is minimized.

In this way, according to an embodiment of the present disclosure, the accuracy of metric estimation of the depth refinement model may be improved by comparing the plurality of depth maps with the correct depth map at various points in time.

Meanwhile, the above-described spatial reconstruction method may also be performed by the AI server 200. When performed by the AI server 200, the depth refinement model 450 may be learned by the learning processor 240 or processor 260 of the AI server 200.

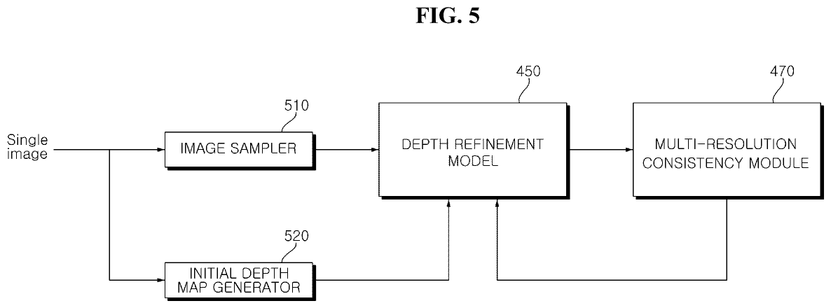

FIG. 5 is a drawing for explaining the configuration of an artificial intelligence device according to another embodiment of the present disclosure.

The artificial intelligence device 100 may include an image sampler 510, an initial depth map generator 520, the depth refinement model 450, and the multi-resolution consistency module MRCM, 470.

The image sampler 510, the initial depth map generator 520, and the MRCM 470 may be included in either the learning processor 130 or the processor 180 of the artificial intelligence device 100.

The depth refinement model 450 may be stored in either the memory 170 or the processor 180.

The image sampler 510 may generate the plurality of sampling data from the single image 410 through the plurality of sampling methods. The plurality of sampling methods may include a segmentation mask method based on the SAM 2 Segment Anything Model 2, 420, the random image segment sub-sampling method, and the pixel shuffling method.

The initial depth map generator 520 may generate the initial depth map 411 from the single image 410 using the monocular depth estimation network.

The depth refinement model 450 may output the plurality of depth maps from the initial depth map 411 and the sampling data 431, 432, 433.

The multi-resolution consistency module MRCM, 470 may add up the first loss Lsam, the second loss Lsub, the third loss Lshuffle_gt, and the fourth loss Lsube and transfer the added value to the depth refinement model 450.

The depth refinement model 450 may adjust the weights so that the summed value is minimized.

In another embodiment, the AI server 200 may include the image sampler 510, the initial depth map generator 520, the depth refinement model 450, and the multi-resolution consistency module MRCM, 470.

The image sampler 510, the initial depth map generator 520, and the MRCM 470 may be included in either the learning processor 240 or the processor 260 of the AI server 200.

The depth refinement model 450 may be stored in either the memory 230 or the processor 260.

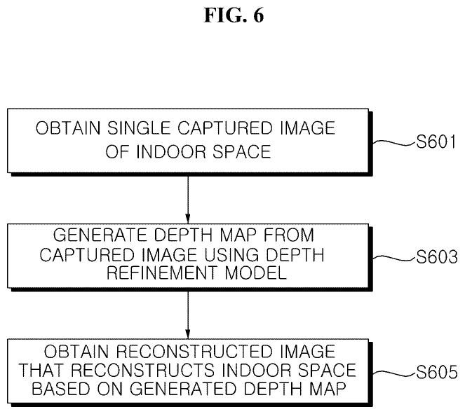

FIG. 6 is a flowchart illustrating a method for generating a reconstructed image from a captured image according to one embodiment of the present disclosure.

FIG. 6 assumes that the learning of the depth refinement model 450 is completed.

The processor 180 of the artificial intelligence device 100 may obtain a single captured image of an indoor space S601.

The processor 180 may obtain an RGB-type captured image of the indoor space through the camera 121.

The processor 180 may generate a depth map from the captured image using the depth refinement model for which learning has been completed S603.

The processor 180 may obtain the plurality of sampling data from the captured image through the plurality of sampling methods.

The processor 180 may input the captured image and the plurality of sampling data into the depth refinement model 450 to obtain a plurality of depth maps.

In one embodiment, the processor 180 may output any one of the plurality of depth maps as the final result. For example, the processor 180 may determine the depth map with the smallest error among the plurality of depth maps as a final depth map.

In another embodiment, the processor 180 may combine the plurality of depth maps to generate a single depth map. The processor 180 may assign weights to each of the plurality of depth maps and generate the final depth map based on the result of the weighting.

Among the depth map considering the first sampling data 431, the depth map considering the second sampling data 432, and the depth map considering the third sampling data 433, a higher weight may be given to a depth map with a higher edge accuracy.

The depth map has the same resolution as the input RGB format captured image and may be a precisely processed map.

The processor 180 may obtain a reconstructed image that reconstructs the indoor space based on the generated depth map S605.

The processor 180 may obtain the reconstructed image from the depth map through a Poisson Surface Reconstruction Network.

The Poisson surface reconstruction network may be a network that reconstructs irregular and noisy 3D points into a 3D mesh. The Poisson surface reconstruction network may be stored in memory 170.

The 3D mesh may be a 3D model composed of triangles or quadrilaterals.

The processor 180 may obtain the result of rendering the 3D mesh as the reconstructed image. The rendering process may be a process of generating the reconstructed image from the 3D mesh using the 3D mesh, a camera viewpoint, a texture, a material, and lighting information. In other words, the reconstructed image may be an image rendered based on the 3D mesh.

The processor 180 may receive a user input for placing a home appliance image corresponding to a home appliance on the reconstructed image, and may position the image of the home appliance on the reconstructed image according to the received user input.

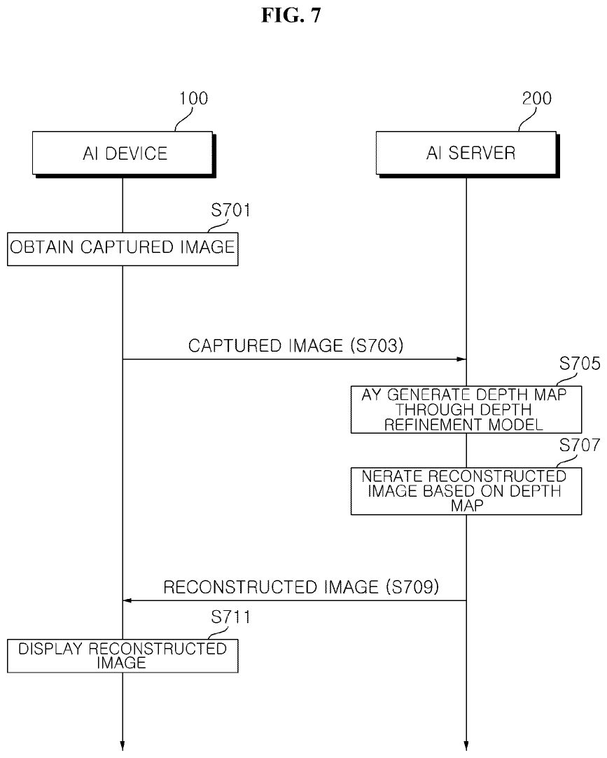

FIG. 7 is a sequence diagram illustrating an artificial intelligence-based spatial reconstruction method of a system according to one embodiment of the present disclosure.

Referring to FIG. 7, the processor 180 of the artificial intelligence device 100 may obtain a single captured image of the indoor space through the camera 121 S701.

The processor 180 may obtain an RGB-type captured image of an indoor space through a camera 121.

The processor 180 of the artificial intelligence device 100 may transmit the captured image to the AI server 200 through the communication interface 110 S703.

The processor 260 of the AI server 200 may generate a depth map from the captured image through the depth refinement model 450 stored in the memory 230 S705, and may generate a reconstructed image that reconstructs the indoor space based on the generated depth map S707.

The depth refinement model 450 may also be trained by the AI server 200.

The processor 260 may obtain the plurality of sampling data from the captured image through the plurality of sampling methods.

The processor 260 may input the captured image and the plurality of sampling data into the depth refinement model 450 to obtain the plurality of depth maps.

In one embodiment, the processor 260 may output any one of the plurality of depth maps as the final result. For example, the processor 260 may determine the depth map with the smallest minimum error among the plurality of depth maps as the final depth map.

In another embodiment, the processor 260 may combine the plurality of depth maps to generate a single depth map. The processor 260 may assign weights to each of the plurality of depth maps and generate the final depth map based on the result of the weighting.

Among the depth map considering the first sampling data 431, the depth map considering the second sampling data 432, and the depth map considering the third sampling data 433, a higher weight may be given to a depth map with a higher edge accuracy.

The depth map has the same resolution as the input RGB format captured image and may be a precisely processed map.

The processor 260 may obtain a reconstructed image from the depth map through the Poisson Surface Reconstruction Network. For a description related to this, refer to step S605.

The processor 260 of the AI server 200 may transmit the generated reconstructed image to the artificial intelligence device 100 through the communication interface 210 S709.

The processor 180 of the artificial intelligence device 100 may display the received reconstructed image on the display 151 S711.

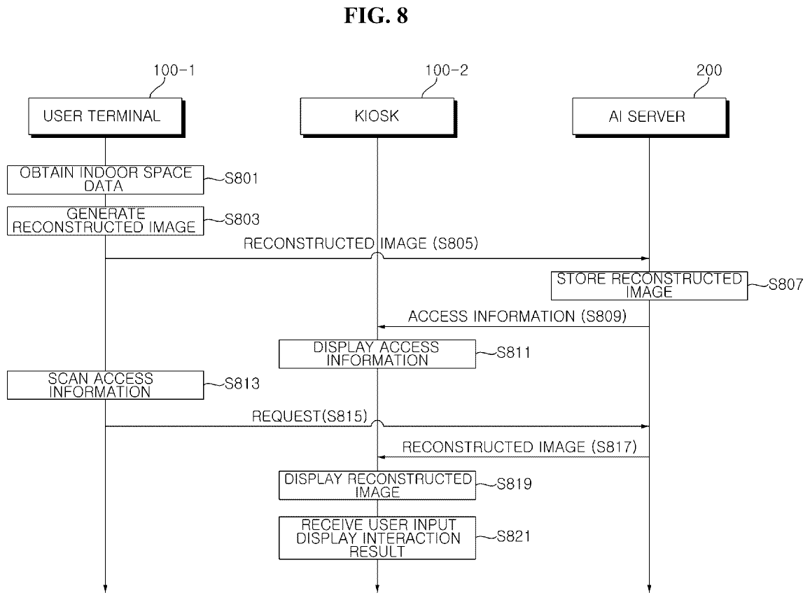

FIG. 8 is a sequence diagram of a system for explaining a method for providing a customized retail experience service according to one embodiment of the present disclosure.

The system may include a user terminal 100-1, a kiosk 100-2, and the AI server 200. Each of the user terminal 100-1 and the kiosk 100-2 may be an example of the artificial intelligence device 100 of FIG. 1.

Referring to FIG. 8, the user terminal 100-1 may obtain indoor space data S801 and generate a reconstructed image of the indoor space based on the obtained indoor space data S803.

The indoor space data may include at least one of a captured image of the indoor space, actual measurement data of the indoor space, or a floor plan image of the indoor space.

In one embodiment, the user terminal 100-1 may generate a plurality of sampling data from a captured image through the plurality of sampling methods, and input the captured image and the plurality of sampling data into the depth refinement model 450 to obtain a plurality of depth maps.

The user terminal 100-1 may generate a final depth map based on the plurality of depth maps according to the descriptions in steps S603 and S605, and may generate a reconstructed image from the final depth map generated through the Poisson surface reconstruction network.

In another embodiment, the user terminal 100-1 may generate a reconstructed image based on actual measurement data of the indoor space. The actual measurement data may include one or more of a width, a height, and a height each of a floor, a ceiling, and a room, or a location each of the floor, the ceiling, and the room. The processor 260 may generate a 3D mesh using the actual measurement data, and may generate a reconstructed image from the generated 3D mesh.

The user terminal 100-1 may store the generated reconstructed image in a Universal Asset Platform (UAP). The UAP may be a database that stores reconstructed images based on indoor space data and 3D assets representing electronic devices.

The user terminal 100-1 may transmit the generated reconstructed image to the AI server 200 S805, and the AI server 200 may store the reconstructed image S807, generate access information for accessing the reconstructed image, and transmit the generated access information to the kiosk 100-2 S809.

In one embodiment, the access information may be a QR code, but this is merely an example. The QR code may include an access address or a link for accessing the reconstructed image generated based on indoor space data.

The kiosk 100-2 may display the received access information S811.

The user terminal 100-1 may scan the access information S813 and transmit a request to the AI server 200 to receive a reconstructed image based on the scan of the access information S815.

The kiosk 100-2 may display the received reconstructed image S819.

The kiosk 100-2 may receive a 3D asset representing an electronic device and the reconstructed image from the AI server 200. The 3D asset represent the electronic device and may be a 3D modeled asset. The 3D asset may be referred to as a 3D object.

The 3D asset may represent the electronic device that a user wishes to purchase. The 3D asset may be extracted from the UAP, as described below.

The kiosk 100-2 may display the reconstructed image using a digital human assistant. The digital human assistant may be an AI-based software agent that guides a user and provides an answer to a question about the electronic device on display.

The kiosk 100-2 may display an interaction result with the 3D object upon receiving a user input for the 3D object representing the electronic device included in the reconstructed image S821.

The interaction result may include one or more of any feedback provided to the user based on the received user input or a changed state of the 3D object.

Specifically, the interaction result may include at least one of the following: a placement of a 3D object within the reconstructed image, a purchase of the electronic device corresponding to the 3D object, switching of a view point indicating a view angle of the 3D object, playing of an animation indicating a movement sequence of object components constituting the 3D object, display of a text, or display of an image.

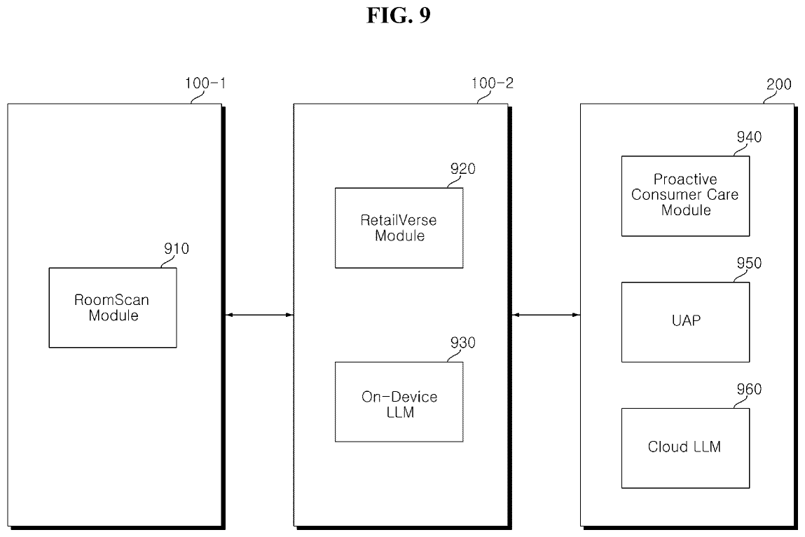

FIG. 9 is a drawing illustrating the configuration of a system according to another embodiment of the present disclosure.

The user terminal 100-1 may further include a room scan module 910.

The room scan module 910 may be included in the processor 180 of the user terminal 100-1 or may be a separately provided element. The room scan module 910 may collect indoor space data. The indoor space data may include at least one of a captured image of the indoor space, actual measurement data of the indoor space, or a floor plan image of the indoor space. The room scan module 910 may collect indoor space data through a user input. The room scan module 910 may generate a 3D mesh based on the indoor space data, and may generate a reconstructed image based on the generated 3D mesh.

The kiosk 100-2 may further include a retail bus module 920 and an on-device LLM 930.

The retail bus module 920 and the on-device LLM 930 may be included in the processor 180 of the kiosk 100-2 or may be separately provided components.

The on-device LLM 930 may be stored in the memory 170 of the user terminal 100-1 or kiosk 100-2.

The retail bus module 920 may provide a reconstructed image including a 3D object and output an interaction result through any one of user inputs including a user's touch, voice, or gesture.

The on-device LLM 930 may be a large language model that provides a digital human assistance service. The on-device LLM 930 may provide a response to a user question. The question may be about a function of the electronic device or about purchasing the electronic device.

The AI server 200 may further include a proactive consumer care module 940, a UAP 950, and a cloud LLM 960.

The proactive consumer care module 940 may provide an after-care service for the electronic device purchased by the user.

The UAP 950 may be a database that stores a plurality of 3D assets corresponding to each of a plurality of electronic devices and a reconstructed image based on indoor space data. The UAP 950 may be provided separately from the AI server 200.

The cloud LLM 960 may be a large language model that provides the digital human assistance service. The cloud LLM 960 may provide a response to a user question. Compared to the on-device LLM 930, the cloud LLM 960 may output a response to a complex and difficult question. The AI server 200 may receive the user question from the AI device 100, generate the response to the question, and transmit the generated response to the AI device 100.

The cloud LLM 960 may be stored in the memory 230 of the AI server 200.

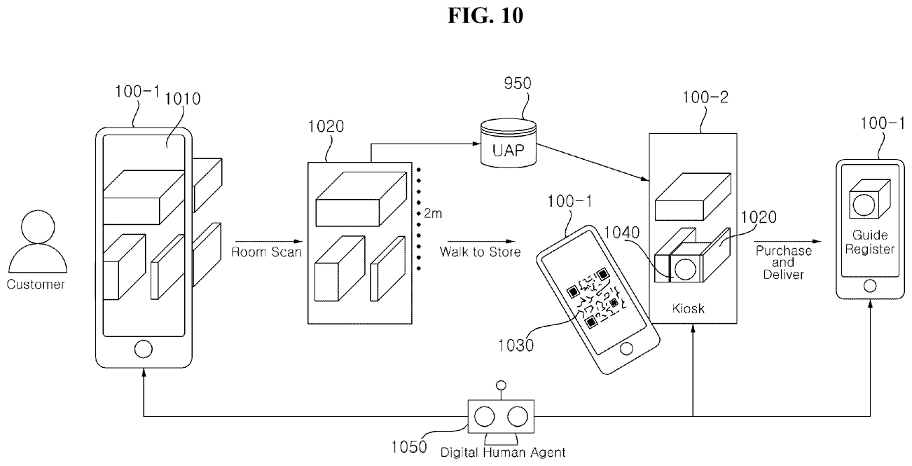

FIG. 10 is a diagram illustrating a scenario for providing a customized retail experience service according to one embodiment of the present disclosure.

Referring to FIG. 10, the user terminal 100-1 may scan an indoor space (or room scan) according to a customer's shooting command to obtain a captured image 1010.

The user terminal 100-1 may generate a 3D mesh or a reconstructed image 1020 from the captured image 1010 through the room scan module 910. The reconstructed image 1020 may be stored in the UAP 950.

A customer visits a store selling the electronic device and scans a QR code 1030 displayed on a kiosk 100-2 installed in the store using the user terminal 100-1. According to the scan of the QR code 1030, the user terminal 100-1 may access the AI server 200 and request that the reconstructed image 1020 be transmitted to the kiosk 100-2.

The AI server 200 may extract a reconstructed image 1020 from the UAP 950 in response to a request and transmit the extracted reconstructed image 1020 to the kiosk 100-2.

The kiosk 100-2 may receive and display the reconstructed image 1020 from the UAP 950. The kiosk 100-2 may request a 3D object 1040 from the UAP 950 based on a user input, and may receive and display the 3D object 1040 based on the request.

The user may load the 3D object 1040 onto the reconstructed image 1020 corresponding to a desired indoor space and place it in a desired location. During this process, interaction with a digital human agent 1050 may occur.

The kiosk 100-2 may output an interaction result for the 3D object 1040 according to a user input.

The user may receive a service related to purchasing and delivering electronic device through the kiosk 100-2.

Meanwhile, the digital human agent (or digital human assistant, 1050) may guide the user through the On-Device LLM 930 or the cloud LLM 960 and provide a response to a question about the displayed electronic device.

When the customer visits a store, communication and consultation often fails, resulting in unnecessary complaint and dissatisfaction with the service. The system according to the embodiment of the present disclosure may identify a customer preference through an interaction with the digital human agent 1050, enabling it to accurately identify customer needs better than a real customer service representative.

Additionally, according to an embodiment of the present disclosure, the customer may easily check whether the home appliance fits well into a desired space through the 3D object 1040 and the reconstructed image 1020.

Furthermore, according to embodiments of the present disclosure, the system may simplify the purchase of a large home appliance by streamlining the process. Instead of having to browse through lengthy catalogs to find the most suitable device, this self-service system allows customers to select the device that best suits their needs through a simpler and more personalized experience.

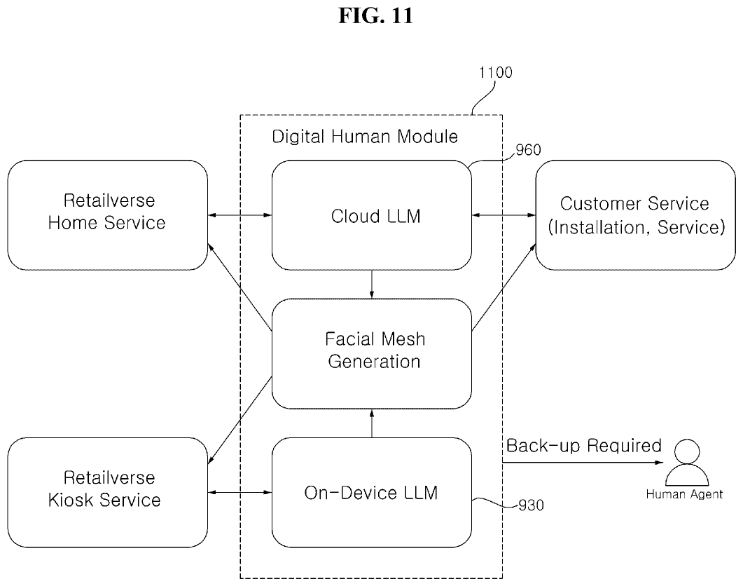

FIG. 11 is a drawing for explaining the configuration of a digital human module according to one embodiment of the present disclosure.

The digital human module 1100 may include the on-device LLM 930 and the cloud LLM 960.

The digital human module 1100 may provide a retail bus home service that provides a personalized environment such as a virtual showroom through the user terminal 100-1 in the home, a retail bus kiosk service that provides a customized retail experience through the kiosk 100-2, and a customer service related to a product installation and an inquiry.

In stores equipped with kiosks 100-2, a customer interaction may be improved by providing the retail bus kiosk service by integrating cloud LLM 960 and on-device LLM 930.

The three services may be integrated with a face mesh generation pipeline that assigns a human face to an audio generated from the on-device LLM 930 and the cloud LLM 960.

In addition to the digital human agent 1050, the system may ping a backup agent in a situation where higher privilege is required, thereby providing the customer with information corresponding to the higher privilege from the backup agent.

A device 100 according to an embodiment of the present disclosure may comprise a memory (170) configured to store a depth refinement model (450); and a processor (180) configured to: acquire a single image representing an indoor space, generate an initial depth map from the single image, generate a plurality of sampling data from the single image, generate a plurality of depth maps from the initial depth map and the plurality of sampling data through the depth refinement model, calculate a plurality of losses representing differences between each of the plurality of depth maps and a correct depth map, and train the depth refinement model such that a sum of the calculated plurality of losses is minimized.

wherein the plurality of sampling data comprises a first sampling data generated according to a Segment Anything Model 2(SAM 2)-based segmentation mask method that automatically generates a segmentation mask for each of a plurality of objects within the single image, a second sampling data generated by a random image segment sub-sampling method that divides the single image into a plurality of image segments of small size and randomly selects some of the divided plurality of image segments, and a third sampling data generated according to a pixel shuffling method that converts a spatial resolution of the single image into channel information.

The depth refinement model (450) comprises an encoder and a decoder skip-connected based on a residual network, and wherein the encoder is configured to compress the initial depth map with added noise and the first to third sampling data to generate a plurality of feature maps, and the decoder is configured to generate the plurality of depth maps by restoring each of the plurality of feature maps.

The plurality of losses comprises a first loss representing a difference between the first depth map generated based on the first sampling data and the correct depth map, a second loss indicating a difference between the second depth map generated based on the second sampling data and the correct depth map, a third loss representing a difference between the third depth map generated based on the third sampling data and the correct depth map, and a fourth loss representing a difference between the compressed feature map generated based on the third sampling data and the correct depth map, and the processor (180) may update weights of the depth refinement model 450 such that a sum of the first to fourth losses is minimized.

The processor (180) may input a single captured image of the indoor space into the depth refinement model (450) for which learning has been completed to obtain a final depth map.

The processor (180) may obtain a 3D mesh reconstructing the indoor space from the final depth map through a Poisson surface reconstruction network.

The processor (180) may generate the initial depth map through an artificial neural network-based model trained to estimate a depth of each of a plurality of pixels constituting the single image from the single image.

In the present invention, the circuits, units, or means may be hardware designed or programmed to perform the specified functions. The hardware may be the hardware disclosed in the present invention or other known hardware programmed or configured to perform the specified functions. If the hardware is a processor, which may be considered a type of circuit, the circuits, units, or means may be a combination of hardware and software, and the software may constitute the hardware and/or the processor.

The above-described present disclosure may be implemented as a computer-readable code on a medium in which a program is recorded. The computer-readable medium includes all kinds of recording devices in which data that may be read by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. In addition, the computer may include the processor 180 of an artificial intelligence device.

What is claimed is:

1. A device, comprising:
a memory configured to store a depth refinement model; and
a processor configured to:
acquire a single image representing an indoor space,
generate an initial depth map from the single image,
generate a plurality of sampling data from the single image,
generate a plurality of depth maps from the initial depth map and the plurality of sampling data through the depth refinement model,
calculate a plurality of losses representing differences between each of the plurality of depth maps and a correct depth map, and
train the depth refinement model such that a sum of the calculated plurality of losses is minimized.

2. The device of claim 1, wherein the plurality of sampling data comprises:
a first sampling data generated according to a Segment Anything Model 2(SAM 2)-based segmentation mask method that automatically generates a segmentation mask for each of a plurality of objects within the single image,
a second sampling data generated by a random image segment sub-sampling method that divides the single image into a plurality of image segments of small size and randomly selects some of the divided plurality of image segments, and
a third sampling data generated according to a pixel shuffling method that converts a spatial resolution of the single image into channel information.

3. The device of claim 2, wherein the depth refinement model comprises an encoder and a decoder skip-connected based on a residual network, and
wherein the encoder is configured to compress the initial depth map with added noise and the first to third sampling data to generate a plurality of feature maps, and the decoder is configured to generate the plurality of depth maps by restoring each of the plurality of feature maps.

4. The device of claim 3, wherein the plurality of losses comprises:
a first loss representing a difference between the first depth map generated based on the first sampling data and the correct depth map,
a second loss indicating a difference between the second depth map generated based on the second sampling data and the correct depth map,
a third loss representing a difference between the third depth map generated based on the third sampling data and the correct depth map, and
a fourth loss representing a difference between the compressed feature map generated based on the third sampling data and the correct depth map, and
wherein the processor is further configured to update weights of the depth refinement model such that a sum of the first to fourth losses is minimized.

5. The device of claim 4, wherein the processor is further configured to input a single captured image of the indoor space into the depth refinement model for which learning has been completed to obtain a final depth map.

6. The device of claim 5, wherein the processor is further configured to obtain a 3D mesh reconstructing the indoor space from the final depth map through a Poisson surface reconstruction network.

7. The device of claim 1, wherein the processor is further configured to generate the initial depth map through an artificial neural network-based model trained to estimate a depth of each of a plurality of pixels constituting the single image from the single image.

8. A method for reconstructing a spatial of a device, comprising:
acquiring a single image representing an indoor space;
generating an initial depth map from the single image;
generating a plurality of sampling data from the single image;
generating a plurality of depth maps from the initial depth map and the plurality of sampling data through a depth refinement model;
calculating a plurality of losses representing differences between each of the plurality of depth maps and a correct depth map; and
training the depth refinement model such that a sum of the calculated plurality of losses is minimized.

9. The method of claim 8, wherein the plurality of sampling data comprises:
a first sampling data generated according to a Segment Anything Model 2(SAM 2)-based segmentation mask method that automatically generates a segmentation mask for each of a plurality of objects within the single image,
a second sampling data generated by a random image segment sub-sampling method that divides the single image into a plurality of image segments of small size and randomly selects some of the divided plurality of image segments, and
a third sampling data generated according to a pixel shuffling method that converts a spatial resolution of the single image into channel information.

10. The method of claim 9, an encoder and a decoder skip-connected based on a residual network, and
wherein the encoder is configured to compress the initial depth map with added noise and the first to third sampling data to generate a plurality of feature maps, and the decoder is configured to generate the plurality of depth maps by restoring each of the plurality of feature maps.

11. The method of claim 10, wherein the plurality of losses comprises:
a first loss representing a difference between the first depth map generated based on the first sampling data and the correct depth map,
a second loss indicating a difference between the second depth map generated based on the second sampling data and the correct depth map,
a third loss representing a difference between the third depth map generated based on the third sampling data and the correct depth map, and
a fourth loss representing a difference between the compressed feature map generated based on the third sampling data and the correct depth map, and
wherein the training comprises:
updating weights of the depth refinement model such that a sum of the first to fourth losses is minimized.

12. The method of claim 11, further comprising:
inputting a single captured image of the indoor space into the depth refinement model for which learning has been completed to obtain a final depth map.

13. The method of claim 12, further comprising:
obtaining a 3D mesh reconstructing the indoor space from the final depth map through a Poisson surface reconstruction network.

14. The method of claim 8, wherein the generating comprises:
generating the initial depth map through an artificial neural network-based model trained to estimate a depth of each of a plurality of pixels constituting the single image from the single image.

15. A non-transitory recording medium storing computer-readable instructions that, when executed by a device, cause the device to perform operations,
wherein the operations comprises:
acquiring a single image representing an indoor space;
generating an initial depth map from the single image;
generating a plurality of sampling data from the single image;
generating a plurality of depth maps from the initial depth map and the plurality of sampling data through a depth refinement model;
calculating a plurality of losses representing differences between each of the plurality of depth maps and a correct depth map; and
training the depth refinement model such that a sum of the calculated plurality of losses is minimized.
